(19) United States
(12) Patent Application Publication
(10) Pub. No.: US 2004/0008870 A1
(43) Pub. Date: Jan. 15, 2004

(54) Electro-optical method and apparatus for evaluating protrusions of fibers from a fabric surface

(76) Inventors: Arkady Cherkassky, Rishon-Lezion (IL); Amotz Weinberg, Tel Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/601,858

(22) Filed: Jun. 24, 2003

Related U.S. Application Data
(60) Provisional application No. 60/390,465, filed on Jun. 24, 2002.

(51) Int. Cl. G06K 9/00

(52) U.S. Cl. 382/111; 382/156

(57) ABSTRACT

An electro-optical method and apparatus for evaluating the dimensions of any protrusion from the threshold of the fabric surface is achieved by bending any length of fabric over a rotating roller so that the contoured area of the protrusion body above the surface can be visualized. The image of the contour as seen by a digital camera is processed statistically and then by a neural network to yield an integrated picture of the fabric protrusions. The grading results of pilling are well correlated to the visual method of pilling evaluation.

### RELATED APPLICATIONS

This application claims the benefit of provisional application serial No. 60/390,465, filed on Jun. 24, 2002, which is incorporated in its entirety by reference herein.

### BACKGROUND OF THE INVENTION

Fabric pilling is a serious problem for the textile and the apparel industry. Pilling is a fabric surface fault in which “pills” of entangled fibers protrude from the fabric surface. They give a bad appearance and can sometimes deteriorate the properties of the fabric. The development of surface hairiness may be an important factor in degrading the quality of certain fabrics and papers.

Due to the importance of the subject, the process of pill formation in fabrics by rubbing action has been thoroughly investigated. Consequently, there are many different test methods that have been developed to determine the resistance of fabrics to pilling. The measurement of pills is performed in two stages. The first entails the formation of pills by means of a laboratory test apparatus—all pill-formation apparatus is based on either tumbling or abrading the test specimen. The second stage is the evaluation of the pilling degree by subjective methods. This is done by comparing the pilled samples with a set of standard photographs or holograms that portray samples of fabrics with various degrees of pilling severity. Other methods involve the manual counting and weighing of the pills.

The pilling standards that are used to grade the samples of tested fabric are on the following scale: 5=no pills; 4=slight pilling; 3=moderate pilling; 2=severe pilling; 1=very severe pilling

The development of an objective method of pill grading is a valuable contribution to the field of fabric testing.

Methods and apparatus for inspecting fabric surfaces are quite common. Lane in U.S. Pat. No. 5,774,177 describes an apparatus for automatically detecting defects within the field of view of a video camera. The image received is then processed by a blob analysis to identify the defects. Vachtsevanos et al, in U.S. Pat. No. 5,936,665 describes an automated apparatus for counting “pills” in textile fabrics. This patent utilizes a CCD camera to capture an area of the fabric surface. The image of the surface is then processed for counting the “pills” and the data is fuzzified to determine the membership of the data in one or more of a plurality of fabric classes. In these examples and other, an area of the tested fabric is illuminated, captured by electro-optical apparatus and the data is processed to yield the characteristic data of the fabric surface.

The present invention relates to imperfections protruding from the fabric surface such as fibers, yarns and pilling. The method involved is bending the fabric so that the examined surface would be external and viewing the silhouette of the bending line as it progresses along the fabric. The analysis of the image becomes one dimensional and the problem of detecting all the objects on the surface of the fabric is resolved by an image processing method. The grading of the pilling severity is based on Neural Network classification.

### SUMMARY OF THE INVENTION

The present invention describes a method and apparatus for grading the severity of pilling or hairiness of fabric samples that were exposed to surface friction. The fabric sample is folded along its width by means of a rotating tube. A digital camera captures the profile of the fold and transmits the profile images to a computer. The rotating tube further moves along the fold in small increments and another picture is taken. This process continues until the complete sample area is scanned. The data is processed by an image processing methods and the results are transformed into the existing grading scale.

### BRIEF DESCRIPTION OF THE DRAWING

FIG. 1 illustrates the basic components of the pilling grading system.

FIG. 2 illustrates the elements and the structure of the Profile Capture Unit.

FIG. 3 is a presentation of the flow chart of the pilling evaluation procedure.

FIG. 4 is a presentation of the flow chart of the Image Processing Unit.

FIG. 5 illustrates the image of the typical profile in the cross-section of a fabric the output of Profile Capture Unit.

FIG. 6 illustrates the BW-image of the profile presented on FIG. 5.

FIG. 7 illustrates the border for the outliers' detection and analysis.

FIG. 8 illustrates the structure of the Neural Network for pilling grading.

### A DETAILED DESCRIPTION OF THE PREFERED EMBODIMENTS

This is an invention of a method and apparatus for inspecting the surface of fabrics that have been exposed to friction and as a result may have been damaged. The damage caused is depicted by fibers or pilling protruding from the said surface. The assessment of the severity of the damage of pilling or hairiness must take into account the size and the number of pilling points per unit area. The present grading system is based on a subjective comparison of the damaged fabric surface to a set of standard photographs or holograms that rank the damage from very severe (scale 1) to no damage (scale 5). It is beneficial to adjust any new method of damage evaluation to the traditional scale.

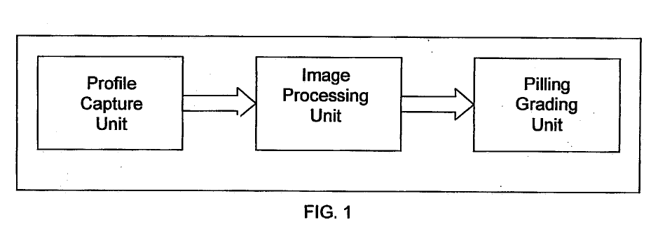

The structure of the grading device is described schematically in FIG. 1.

The Profile Capture Unit photographs the profile of the bend in the fabric and transmits the data to the Image Processing Unit. The output data of the Image Processing Unit is fed into the Pilling Grading Unit that integrates the results of the fabric surface protrusion into a grading system, using Neural-Network and database and correlates the existing manual grading scale to this system's results.

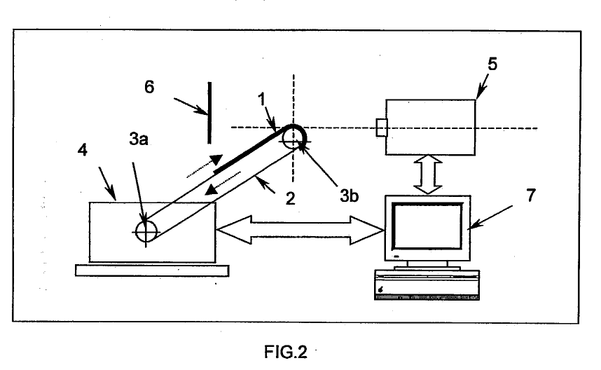

FIG. 2 illustrates the elements in the Profile Capture Unit.

A strip of fabric 1 that was treated to induce pilling by a standard method (such as ASTM 3512-99 or B.S. 581186 or M&S P18A or other) is attached to a conveyer belt 2 by clips (not shown in the drawing). The width of the conveyer belt is 15 cms. and its linear length is typically 40 cms. The conveyer belt surfaces are placed at an angle of about 45 degrees to the horizontal, and are wound around two pulleys 3a and 3b, each of about 1 cms. in diameter. The lower pulley 3a is powered by an electric step motor 4 that rotates the pulley in linear increments of 0.1 to 0.5 cms.

A digital camera 5 is placed on a stand so that its lens is within the focal distance of the top of the fabric that has been wound onto the top pulley 3b. A screen 6 is placed behind the top of the fabric surface and serves as a background to the silhouette of the fabric line above the upper pulley as captured by the camera. The color of the front surface of the screen that is facing the camera lens can be changed to contrast the color of the tested fabric. If necessary, the screen can be translucent and the illumination of the sample would be projected on the back surface. A PC computer 7 synchronizes the movement of the conveyer belt to the camera exposure. After each exposure, the conveyer belt moves the tested fabric by a preset increment.

The PC computer determines the border between the fabric and the background, and also the threshold line of the fabric fold—that is the line that would be seen when all surface obstacles are removed. The decision of the position of the threshold is based on certain parameters that part of the operation procedure. The software processes any protrusion above the threshold line.

It is first transferred to Gray Scale Image where the profile is captured. The outliers are then determined. It is then transferred to Black and White Image. The area of the defined outliers is processed by mathematical and statistical analysis to obtain a two-dimensional evaluation.

The next exposure is analyzed in the same way but the program takes into account the previous exposure and identifies the protrusions that appeared in it. Sequential exposures of the fabric fold reveal a gradual increase and then decrease in the cross-section of each protrusion. Hence, the actual size of the protrusions, in two directions, can be determined. The data obtained from the series of exposures of the advancing folds in the fabric enables an accurate measure of the number of protrusions, the size of the individual protrusions and their density (number per unit. area of fabric). This is the essential data required for assessing damage to the fabric from protrusions such as pilling

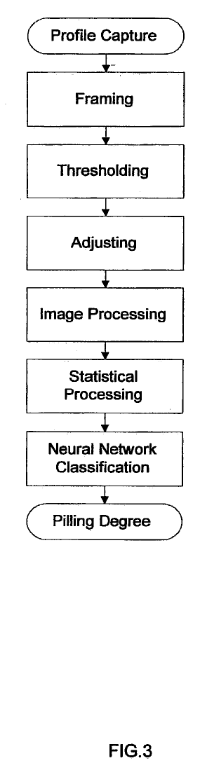

The Flow chart of the pilling evaluation procedure is shown on FIG. 3. The first three stages after Profile Capture are designed for preparing the Image Processing Procedure. The Framing and Thresholding are used to select the borders of the profile image and to transform the gray scale image to the black/white (BW) image necessary for the image processing. The operator determines the parameters of the Image Processing program such as the number of profiles, the parameter of the average smoothness, and the threshold for the outliers. The length, height, area and the distance between the outliers for each specific profile increase as a result of the image processing.

The next stage is Statistical Processing. The purpose of this stage is to calculate the average values and the standard deviations for the outliers' parameters for the entire set of profiles for the fabric sample. The results of the Statistical Processing are transmitted to a Neural Network. The Network has specific training data set, and can determine the pilling grading according to the existing scale.

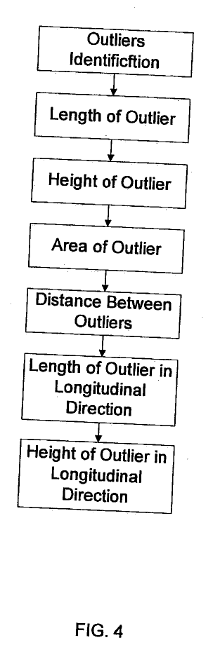

FIG. 4 describes the Image Processing stage in some detail. This stage provides a numeric analysis of each identified outlier for each specific profile. In addition, the distance between every adjacent outlier along a profile (in the cross direction of fabric) is calculated for each specific profile. Sequential analysis of the ordered assembly of the profiles enables the program to determine the length and the height of the outliers in the longitudinal direction.

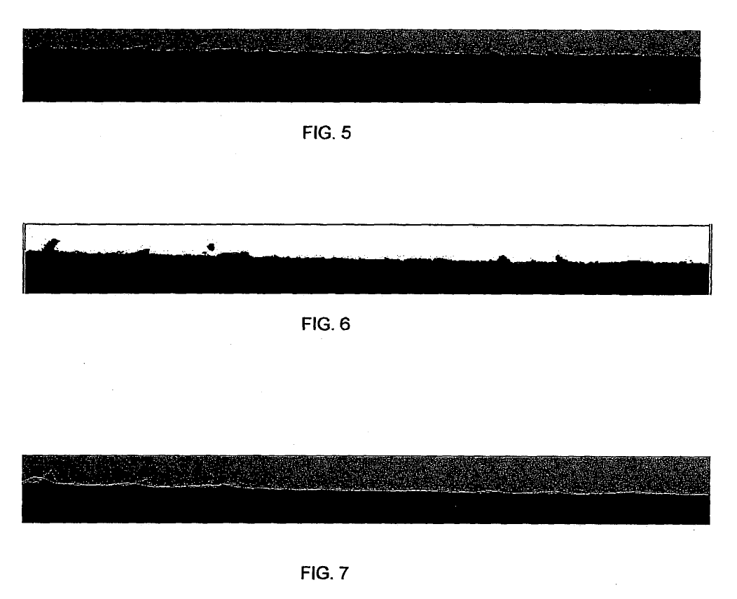

FIG. 5 presents the image of a typical profile of the fold of the fabric as an output of the Profile Capture Unit.

BW—image of the profile—is presented on FIG. 6. This BW—image corresponds to a specific level of the threshold.

The border for the outliers' detection and analysis is shown on FIG. 7. This border is obtained as a result of the average smoothness for the BW-border (as in FIG. 6). The average smoothness eliminates the influence of the bowing of the fabric surface on the result of grading.

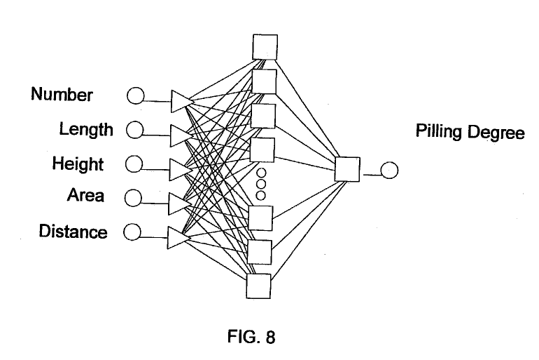

The structure of Neural Network is presented in FIG. 8. The average value of the outliers' parameters for the entire set of profiles of the fabric sample represents the 5-D input of the network. The output of this Neural Network is the value of pilling degree corresponding to a specific set of outlier parameters. The network is designed and trained on the data set. The data set was obtained by expert estimations of the fabric's pilling according to the requirements of ASTM D 3512-96 Standard Test Method for Pilling Resistance and Other Related Surface Changes of Textile Fabrics: Random Tumble Pilling Tester.

In various embodiments of the invention:

A method for the detection of fabric surface and surface protrusions and for the classification of fabric quality according to the geometrical parameters and population density thereof, said method comprising the steps

a. providing a sample of the textile to be classified;

b. bending said sample over a small diameter element;

c. generating a set-off two-dimensional image of the portion of the fabric sample being bent;

d. advancing said fabric sample by a small increment;

e. repeating steps c and d as often as necessary to scan said fabric sample;

f. counting the number of protrusions;

g. measuring and calculating the geometrical parameters of each protrusion;

h. calculating the degree or degrade of said protrusions by means of a neural network; and

The invention may further include the above mechanism wherein the fabric folding is accomplished by a rotating or stationary tube.

The invention may further include the folding mechanism wherein the fabric is folded over a stationary or moving edge.

The invention may further include a detection device wherein any electro-optical device is used for capturing the image of the protrusion silhouette and transfers it to the processor.

The invention may further include that in the background screen the color of its surface seen by the detection device, can be changed.

The invention may further include that the said background screen comprises the opacity or the translucency of the screen can be changed to enhance the contrast of the protrusion silhouette as seen by the detection device.

The invention may further include the method and apparatus for the detection of fabric surface protrusions as described wherein illumination is added to enhance the image captured by the detection device.

The invention may further include the method and apparatus for the detection of fabric surface protrusions as described wherein, the system can calculate the number of protrusions for a tested sample of fabric.

The invention may further include the method and apparatus for the detection of fabric surface protrusions as described wherein the system can calculate the three-dimensional size of the protrusions for a tested sample of fabric.

The invention may further include the method and apparatus for the detection of fabric surface protrusions as described wherein the protrusions are the result of pilling of a fabric surface.

The invention may further include the method and apparatus for the detection fabric surface protrusions as described wherein the parameters of protrusions are processed by a Neural-Network for pilling grading.

The invention may further include the method and apparatus for the detection of fabric surface protrusions wherein the protrusions are the result of hairiness of a fabric surface.

The invention may further include the method and apparatus for the detection fabric of surface protrusions wherein the protrusions are the result of foreign bodies on a fabric surface.

The invention may further include the method and apparatus for the detection fabric of surface protrusions as described wherein the protrusions are apparent on any pliable surface.

1. An apparatus for the detection of fabric surface protrusions and the classification of fabric quality according to the geometrical parameters and population density thereof, said apparatus comprising:
(a) a conveyor mechanism for providing incremental movement of a fabric to be graded supported on said conveyor mechanism, said conveyor including a small-radius element over which successive portions of aid fabric are bent so that the silhouette of said surface protrusions may be viewed as a series of two dimensional images;
(b) a mechanism that intermittently drives said conveyor in a direction perpendicular to the axis of said small-radius element to expose successive bending lines and fabric surface,
(c) a fixed position image capture device focussed on said fabric surface and surface protrusions above the fabric surface and along each of said exposed successive bending lines, said device being actuated automatically when said conveyor is at rest between intermittent movements;
(d) lighting means for said silhouette of said surface and surface protrusions, said lighting means being arranged to provide a constant degree of illumination to said exposed successive bending lines;
(e) a processor arranged to receive data defining a set off successive two dimensional fabric images from said image capture device;
(f) a counting device operationally connected to said processor for recognizing said fabric surface, and surface protrusions and recording the number thereof;
(g) an automatic measuring device connected to said processor for recognizing said fabric surface and surface protrusions and calculating and recording the geometrical parameters of said protrusions; and
(h) a neural network arranged to receive outputs of said counter and said automatic measuring device and to calculate a numeric value corresponding to said geometrical parameters and number of said fabric surface protrusions, and to calculate and display a grade number relating said fabric being tested to corresponding industry grade standards.

2. The mechanism as claimed in claim 1, wherein said small-radius element is rotatable.

3. The mechanism as claimed in claim 1, further provided with a background screen positionable in view of said image capture device so that said image capture device sees said silhouette of said surface and surface protrusions against said background screen.

4. The mechanism as claimed in claim 3, wherein the color of said screen can be changed.

5. The mechanism as claimed in claim 3, wherein the opacity/translucency of said screen can be changed to enhance the contrast of said fabric as seen by said detection device.

6. The mechanism as claimed in claim 1, wherein said automatic measuring device connected to said processor for recognizing said fabric surface and surface protrusions can further calculate and record the three-dimensional volume of said protrusions, based on the set-off successive two dimensional fabric images.

7. An apparatus for the detection of fabric surface protrusions and the classification of fabric quality substantially as described hereinbefore and with reference to the accompanying drawings.

8. A method for the detection of fabric surface and surface protrusions and for the classification of fabric quality according to the geometrical parameters and population density thereof, said method comprising the steps
a. providing a sample of the textile to be classified;
b. bending said sample over a small diameter element;
c. generating a set-off two-dimensional image of the portion of the fabric sample being bent;
d. advancing said fabric sample by a small increment;
e. repeating steps c and d as often as necessary to scan said fabric sample;
f. counting the number of protrusions;
g. measuring and calculating the geometrical parameters of each protrusion;
h. calculating the degree or degrade of said protrusions by means of a neural network; and

9. A method for the classification of fabric quality as claimed in claim 8 wherein the protrusions are the result of pilling of a fabric surface.

10. A method for the classification of fabric quality as claimed in claim 8 wherein the protrusions are the result of snagging of a fabric surface.

11. A method for the classification of fabric quality as claimed in claim 8 wherein said protrusions are the result of hairiness of a fabric surface.

12. A method for the classification of fabric quality as claimed in claim 8 wherein the protrusions are the result of foreign bodies on a fabric surface.
